(19) United States
(12) Patent Application Publication
(10) Pub. No.: US 2021/0082076 A1
(43) Pub. Date: Mar. 18, 2021

(54) SYSTEMS AND METHODS FOR MATCHING PROVIDER DEVICES TO MULTIPLE REQUESTOR DEVICES

(71) Applicant: Lyft, Inc, San Francisco, CA (US)

(72) Inventors: Mayank Gulati, San Francisco, CA (US); Peter Bansuk Lee, San Francisco, CA (US); Guy-Baptiste Richard de Capele d'Hautpoul, San Francisco, CA (US); Krishna Kumar Selvam, San Francisco, CA (US); Charles Parker Sielman, San Francisco, CA (US); Aleksandr Zamoshchin, San Francisco, CA (US)

(21) Appl. No.: 16/718,130

(22) Filed: Dec. 17, 2019

Related U.S. Application Data
(60) Provisional application No. 62/900,529, filed on Sep. 14, 2019.

(51) Int. Cl. G06Q 50/30; G06Q 10/02; G01C 21/34; H04W 4/021

(52) U.S. Cl. CPC G06Q 50/30; G06Q 10/02; H04W 4/021; G01C 21/3438; G01C 21/3415

(57) ABSTRACT

The disclosed computer-implemented method may calculate individual utility metrics for each combination of potential transportation requestors and cancellations to arrive at a more accurate total expected utility for shared transportation. In one embodiment, the method may reduce computation resource requirements by calculating each cancellation probability independently. In some examples, the method may only calculate utility metrics for some fixed number and/or percentage of the most probable combinations. In some embodiments, the method may account for travel time and/or distance when calculating utility metrics. By making matching decisions for shared transportation that account for the possibility of cancellation, the method may improve the efficiency of the transportation network. Various other methods, systems, and computer-readable media are also disclosed.

### CROSS REFERENCE TO RELATED APPLICATION

This application claims the benefit of U.S. Provisional Application No. 62/900,529, filed 14 Sep. 2019, the disclosure of which is incorporated, in its entirety, by this reference. This application relates to co-pending application Ser. Nos. [TBD] and [TBD], filed on same day herewith, the disclosures of which are incorporated, in their entirety, by this reference.

### BACKGROUND

A dynamic transportation matching service may match individuals and groups who request transportation from a starting point to a destination with transportation providers, such as cars, that are associated with a dynamic transportation network managed by the dynamic transportation matching system. In some examples, a dynamic transportation matching service may provide shared transportation for unrelated transportation requestors that may be more economical and/or environmentally friendly than individual transportation. In some embodiments, a dynamic transportation matching system may match multiple transportation requestors with a single transportation provider to facilitate shared transportation.

In some cases, one or more transportation requestors may cancel their transportation requests after being matched but before meeting the transportation requestor. In these situations, a previously efficient combination of transportation requestors and providers may be comparatively less efficient. Accordingly, the instant disclosure identifies and addresses a need for additional and improved systems and methods for matching providers to multiple requestors.

### BRIEF DESCRIPTION OF THE DRAWINGS

The accompanying drawings illustrate a number of exemplary embodiments and are a part of the specification. Together with the following description, the drawings demonstrate and explain various principles of the instant disclosure.

FIG. 1 is an illustration of an example set of transportation requestor devices and a provider device.

FIG. 2 is an illustration of an example set of combinations of requestor devices.

FIG. 3 is an illustration of an example set of utility metrics for different combinations of requestor devices.

FIG. 4 is an illustration of an example set of utility metrics for different combinations of requestor devices.

FIG. 5 is an illustration of an example set of transportation requestor devices and a provider device.

FIG. 6 is a flow diagram of an example method for matching multiple requestor devices with a provider device.

FIG. 7 is an illustration of an example set of transportation requestor devices and a provider device.

FIG. 8 is a block diagram of an example dynamic transportation matching system.

FIG. 9 is a flow diagram of an example method for matching multiple requestor devices with a provider device.

FIG. 10 is an illustration of an example requestor/provider management environment.

FIG. 11 is an illustration of an example data collection and application management system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for matching multiple transportation requestors with a transportation provider. In some situations, shared transportation may consume fewer resources within a dynamic transportation network than private transportation by transporting multiple requestors with a shared transportation resource. However, some requestors may not follow through with a shared transportation match determined by a dynamic transportation matching system (e.g., by cancelling or failing to accept the transportation match), leading to shared transportation that is potentially much less efficient than the shared transportation match originally determined by the dynamic transportation matching system—and, significantly, potentially less efficient than another match that might have been determined by the dynamic transportation matching system. Accordingly, there is a need to match requestors for shared transportation in a way that ensures system resources are utilized efficiently and that is robust to potential cancellations. Rather than evaluating a potential shared ride based on the projection that no transportation requestors will cancel, a more robust method for matching requestors for shared transportation may calculate individual utility metrics for each combination of potential requestors and cancellations (or failures to accept the match) to arrive at a more accurate expected utility metric for the shared ride. In this manner, a dynamic transportation matching system may account for the possibility that a potential shared ride match does not yield a best-case outcome and may determine a probabilistically more efficient shared ride match, thereby improving efficiency within the dynamic transportation network.

In some embodiments, the method may fetch potential matches, filter out potential matches that fail to meet hard constraints (including, e.g., the ETA of the provider to each requestor, the ETD for each requestor, vehicle requirements specified by each requestor, etc.), determine the probability of conversion for each transportation requestor (e.g., the probability that the requestor will not cancel their ride), and efficiently permute different outcomes based on the cancel probability of each transportation requestor. In one embodiment, the method may reduce computation resource requirements by projecting that each cancellation probability is independent of each other cancellation probability. In some examples, the method may only calculate expected values (e.g., utility metrics) for some fixed number and/or percentage of the most probable combinations and/or permutations. In some embodiments, the method may account for travel time, distance, and/or cost when calculating expended values and/or other utility metrics. By making matching decisions for shared rides that are robust to cancellation, the method may improve the transportation provider's experience and/or improve value for the dynamic transportation network. Accordingly, for the reasons mentioned above and to be discussed in greater detail below, the systems and methods described herein may provide advantages to dynamic transportation matching and/or the field of transportation by increasing the efficiency of shared transportation provided by a dynamic transportation network.

As will be explained in greater detail below, a dynamic transportation matching system may arrange transportation on an on-demand and/or ad-hoc basis by, e.g., matching one or more transportation requestors and/or transportation requestor devices with one or more transportation providers and/or transportation provider devices. For example, a dynamic transportation matching system may match a transportation requestor to a transportation provider that operates within a dynamic transportation network (e.g., that is managed by, coordinated by, and/or drawn from by the dynamic transportation matching system to provide transportation to transportation requestors).

In some examples, available sources of transportation within a dynamic transportation network may include vehicles that are owned by an owner and/or operator of the dynamic transportation matching system. Additionally or alternatively, sources of transportation within a dynamic transportation network may include vehicles that are owned outside of the dynamic transportation network but that participate within the dynamic transportation network by agreement. In some examples, the dynamic transportation network may include lane-bound vehicles (e.g., cars, light trucks, etc.) that are primarily intended for operation on roads. Furthermore, the dynamic transportation network may include personal mobility vehicles and/or micro-mobility vehicles that are not bound to traditional road lanes, such as scooters, bicycles, electric scooters, electric bicycles, and/or any other suitable type of personal mobility vehicle and/or micro-mobility vehicle. In some embodiments, a dynamic transportation network may include autonomous vehicles (e.g., self-driving cars) that may be capable of operating with little or no input from a human operator.

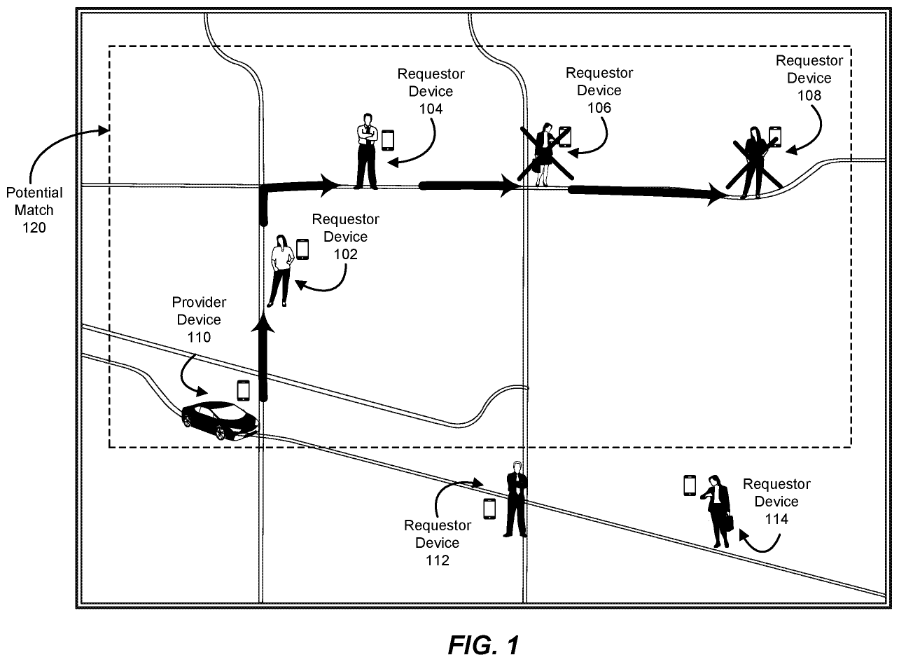

FIG. 1 illustrates an example set of transportation requestor devices and a provider device. In one embodiment, a transportation provider such as a car may be associated with a transportation provider device (e.g., a mobile phone) that may be matched with one or more transportation requestor devices that are each associated with one or more transportation requestors. For example, a potential match 120 may match transportation provider device 110 with requestor devices, 102, 104, 106, and/or 108 that may have compatible pickup points and/or destinations. The term “potential match,” as used herein, may generally refer to any combination and/or permutation of one or more provider devices and two or more requestor devices that has been defined by a dynamic transportation matching system but not executed (e.g., has not been communicated to the involved devices). For example, a potential match for a shared ride (e.g., a trip in a shared transportation mode) may include a provider device and three requestor devices that a provider associated with the provider device is to pick up and drop off in a specified order. In another example, a potential match may include a provider device and three requestor devices in no specified order. In one example, after potential match 120 is executed (e.g., communicated to and/or accepted by the involved devices), requestor devices 106 and/or 108 may cancel requests for transportation, leaving the transportation provider associated with provider device 110 only transporting the transportation requestors associated with requestor devices 102 and/or 104. This combination may be an inefficient use of transportation network resources for various reasons. For example, provider device 110 may be associated with a high-capacity vehicle that is most efficiently utilized transporting more than two transportation requestors, while a lower-capacity vehicle may be more efficient for transportation only two requestors. In addition, the transportation provider associated with provider device 110 may prefer to transport the maximum feasible number of transportation requestors and may be less likely to continue participating in the dynamic transportation network after transporting only two requestors. Had the possibility that requestor devices 106 and/or 108 may cancel been taken into account, another potential match may have been executed. For example, a match involving requestor devices 102, 104, 112, and 114 may have appeared marginally less efficient than potential match 120 when disregarding the possibility that one or more requestor devices cancel their part of the shared transportation. Had provider device 110 instead been matched with requestor devices 102, 104, 112, and 114, the dynamic transportation network might have identified a more efficient and/or higher-value shared transportation. In addition, the experience of the transportation provider might have been improved.

In some examples, the term “shared transportation,” as used herein, may generally refer to any trip where one or more unrelated transportation requestors (i.e., transportation requestors who are not part of a party that requested transportation together from a single starting location) are simultaneously transported by the same transportation provider for any portion of the trip. In some examples, a transportation provider may provide shared transportation by picking up a first transportation requestor at a first location, picking up a second transportation requestor at a second location, dropping off the first transportation requestor at a first destination, and dropping off the second transportation requestor at a second destination, in sequence. Additionally or alternatively, a transportation provider may provide shared transportation by picking up a first transportation requestor at a first location, picking up a second transportation requestor at a second location, dropping off the second transportation requestor at a first destination, and dropping off the first transportation requestor at a second destination, in sequence. In some examples, a transportation provider may provide shared transportation by picking up multiple requestors at the same location but dropping different requestors off at different destinations and/or picking up multiple requestors at different locations but dropping the requestors off at the same destination. In one example, a single trip may include both shared and non-shared transportation. For example, a transportation requestor may use a micro-mobility vehicle to meet up with a transportation provider that is providing transportation to an additional transportation requestor.

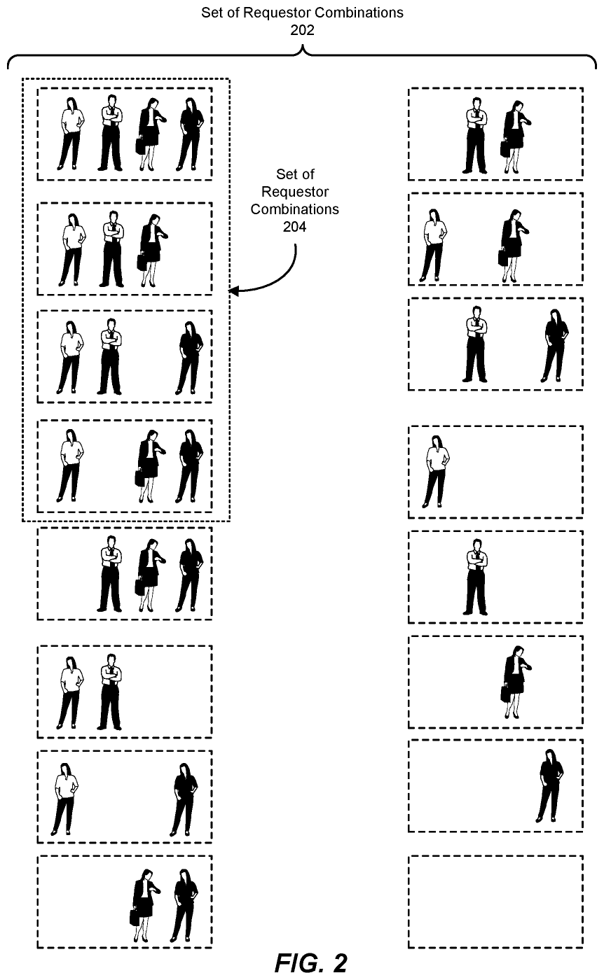

FIG. 2 illustrates an example set of combinations of requestor devices. In some embodiments, rather than matching a provider device with a set of requestor devices based on the projection that no requestor devices will cancel, the systems described herein may calculate the utility to the dynamic transportation matching system of each subset of requestor devices in the potential match based on different projections about which requestor devices will cancel and which requestor devices will not cancel. The term “utility,” in some examples, may refer to any type of value generated for a dynamic transportation matching system. In some embodiments, utility may include monetary value, requestor satisfaction, provider satisfaction, impacts on requestors and/or providers not included in the match including potential future requestors (e.g., increased or decreased delay for other requestors within the dynamic transportation network due to the allocation of transportation resources, increased or decreased provider utilization, etc.), and/or any other relevant factors. In one embodiment, utility may represent an expected value to the transportation system, including monetary value (e.g., an amount of revenue and/or profit to a transportation provider and/or to the dynamic transportation network, in some examples measured as a monetary value metric), efficiency value of transportation provided per amount of transportation resource used (e.g., as measured by a distance metric, a time metric, etc.), and/or utilization value (e.g., the rate at which transportation resources are utilized within the dynamic transportation network, in some examples measured as a utilization value metric). In some embodiments, the term “utility metric” may refer to any measurement, calculation, representation, and/or description of utility. In one embodiment, a utility metric may be a numerical value with no units. For example, a utility metric may not be measured in terms of dollars, minutes, miles, etc. In some examples, the term “projection,” as used herein, may refer to a predicted outcome of a potential match in terms of which requestor devices will cancel and which requestor devices will not cancel. As illustrated in FIG. 2, a set of requestor combinations 202 may include every possible combination of requestor devices 102, 104, 106 and/or 108. The term “requestor combination,” in some examples, may refer to a set of requestor devices. In some examples, a requestor combination may be a subset of requestor devices associated with a potential match. In some embodiments, a requestor combination may have a specified order of requestor devices. In other embodiments, a requestor combination may not have a specified order of requestor devices.

In some embodiments, the systems described herein may calculate a utility metric for every combination in set of requestor combinations 202. Alternatively, the systems described herein may calculate a probability of some or all of the combinations in the set of requestor combinations 202 occurring and may only calculate a utility metric for the most probable combinations, such as set of requestor combinations 204. For example, the systems described herein may calculate a utility metric for a set number of the most probable combinations (e.g., the 4, 8, or 16 combinations most likely to result from various subsets of transportation requestors accepting the match and not cancelling), a set percentage of the most probable combinations (e.g., the 5% or 10% most likely combinations), and/or any combination above a certain probability threshold (e.g., at least 10% probability or at least 20% probability of the combination resulting from the transportation requestors in the combination accepting the match and/or not cancelling). Generally, determining the probability that a potential match that specifies a requestor will ultimately include the requestor may include determining the probability that the requestor will accept the potential match, the probability that the requestor will not cancel the potential match, the probability that a utility of the requestor being included in the match will result, or any combination of the foregoing.

In some embodiments, the systems described herein may only calculate probabilities for combinations that include a certain number of requestors. For example, the systems described herein may be configured with a threshold requirement for calculating the probability that any given combination of requestors will occur. For example, the systems described herein may not spend resources to calculate an exact probability that a particular combination of requestors will end up participating (e.g., accepting and not canceling) upon being matched if the combination involves three or more requestors canceling (e.g., based on an a priori determination that the probability of three or more requestors canceling falls below a given threshold and is, therefore, insignificant). In some embodiments, the systems described herein may consider permutations in addition to combinations. In some examples, a shared transportation route may have a different utility and/or trigger different cancellation probabilities based on the order in which the transportation requestors are picked up and/or dropped off and thus different permutations of the same combination may have different utilities and/or expected values. For example, one permutation may require two requestors to each wait five minutes to meet the transportation provider while a different permutation may require the first requestor to wait one minute and the second requestor to wait nine minutes, increasing the probability that the latter requestor will cancel.

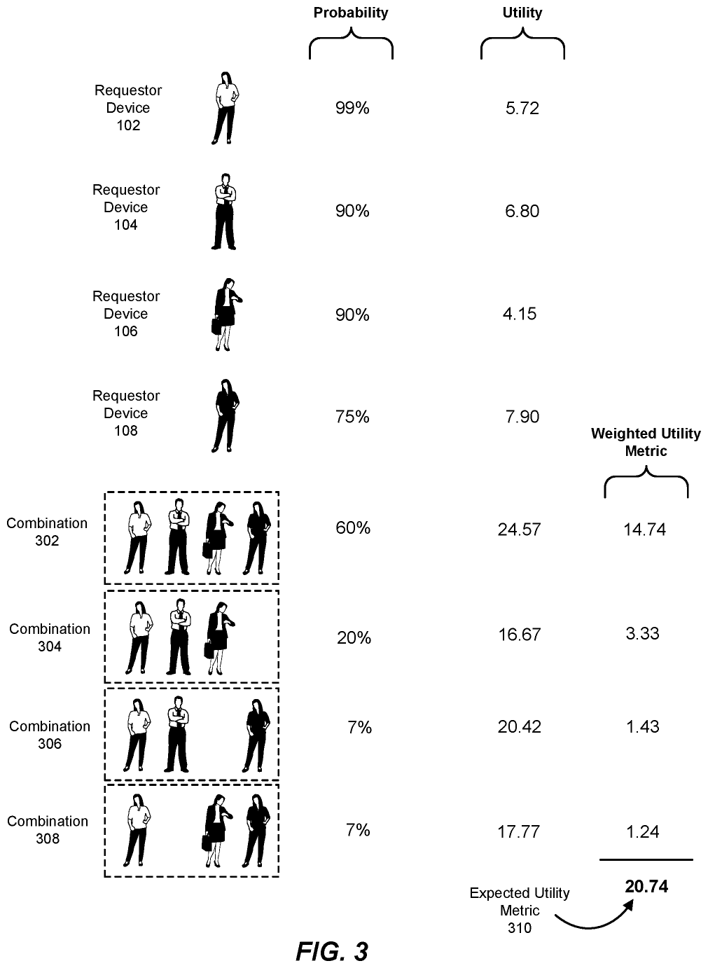

FIG. 3 illustrates an example set of utility metrics for different combinations of requestor devices. In some embodiments, the systems described herein may calculate the utility to the dynamic transportation matching system for a combination of requestor devices by calculating an expected value based on the probability of the particular combination resulting in the case of a match and the utility of the combination to the dynamic transportation matching system if the combination results (e.g., by weighting a utility metric of the combination by the probability that the combination results). The systems described herein may determine value in any of a number of ways. For example, the systems described herein may calculate an expected value and/or utility through one or a combination of any of the time to transport a transportation requestor, the distance a transportation requestor is being transported (e.g., in the context of how much distance is added to the shared transportation route by transporting the transportation requestor and/or in absolute terms), the likelihood of the transportation requestor making future requests for transportation (e.g., based on past requests by the requestor and/or similar requestors), the likelihood of the transportation provider continuing to participate in the dynamic transportation network, monetary value, and/or any additional appropriate factors.

The systems described herein may calculate the probability of a requestor participating in the shared transportation versus cancelling in a variety of ways. For example, the systems described herein may examine previous behavior of the transportation requestor and/or similar transportation requestors in the past. Similar transportation requestors may be identified in any of a variety of ways. For example, similar transportation requestors may be identified based on similar historical behavior (e.g., modes of transportation requested, types of trips taken (length, typical origins and destinations, typical times of day), frequency of participation in the dynamic transportation network, etc.). In other examples, similar transportation requestors may be identified based on being similarly situated (e.g., requesting the same type of transportation, requesting at similar times of day, requesting from similar starting location, requesting similar destinations, requesting under similar traffic conditions, etc.). If a transportation requestor device has never cancelled a request for transportation, the systems described herein may determine that the transportation requestor device has a low probability of cancelling. In some examples, the systems described herein may take into account the context of the transportation request and/or potential match. For example, if the potential match would cause the transportation requestor to have to wait for ten minutes in the rain in an area with no shelter, the systems described herein may use map and weather data to determine that the transportation requestor is more likely to cancel than if the potential match would cause the transportation requestor to wait for a shorter time and/or in more preferable conditions. In some examples, the systems described herein may factor into the calculation the probability of the transportation requestor cancelling due to the current market conditions. For example, the dynamic transportation network may be more heavily utilized at certain times of the day (e.g., during rush hour), leading to increased prices and/or increased wait times, either or both of which may increase the probability that a transportation requestor may cancel. In some embodiments, the systems described herein may take into account time of day, day of the week, traffic, availability of other transit, weather, expected wait time, expected transit time, expected time of arrival at destination, current location, distance from current location to pick-up location, destination location, transportation request history, and/or any other relevant factor as inputs for determining the likelihood that a transportation requestor device may cancel a request for transportation after being matched (e.g., after session conversion).

In one example, the systems described herein may determine that matching transportation requestor device 102 with provider device 110 will provide a utility metric of 5.72 and requestor device 102 has a 99% probability of participating in the shared transportation (i.e., accepting the match and not cancelling). Similarly, the systems described herein may determine that requestor device 104 has a utility metric of 6.80 and a probability of 90%, requestor device 106 has a utility metric of 4.15 and a probability of 90%, and/or requestor device 108 has a utility metric of 7.90 and a probability of 75%. Based on these metrics, the systems described herein may calculate that combination 302, in which all requestor devices in the potential match accept the match and no requestor devices cancel, has a 60% probability of resulting and a utility of 24.57, for an expected utility metric of 14.74. Similarly, the systems described herein may calculate that combinations 304, 306, and/or 308, each of which project that a single transportation requestor device will fail to accept the match or will cancel, may have expected utility metrics of 3.33, 1.43, and/or 1.24, respectively. In one example, the systems described herein may not calculate an expected utility metric for any combination in which requestor device 102 is absent due to the low probability of such combinations resulting (e.g., because requestor device 102 has a high probability of accepting the match and not cancelling). In some embodiments, the systems described herein may sum the expected utility metrics of the set of combinations to arrive at an expected utility metric for the potential match, such as expected utility metric 310. Additionally or alternatively, the systems described herein may combine the expected utility metrics of the set of combinations in other ways and/or include other values, metrics, and/or data when calculating the expected utility metric for the potential match. For example, these systems may compute separate expected utility metrics for a potential match based on different factors (such as ETA of transportation providers to transportation requestors within the dynamic transportation network, geographic placement of transportation providers within the transportation network, participation rates of transportation requestors and/or transportation providers within the dynamic transportation network, etc.) and then combine these separate expected utility metrics in a single algorithm and/or formula to determine whether to execute the potential match. Additionally or alternatively, these systems may account for different factors (such as those listed above) when evaluating the utility of each combination of requestors that may result from the potential match, thereby producing a single expected utility metric that accounts for the different factors. In some examples, the systems described herein may add a constant based on the number of requestors to represent the combinations for which an expected utility metric was not calculated. For example, the systems described herein may add a small constant, such as 0.4, for sets of four requestors or a slightly larger constant, such as 0.6, for sets of six requestors, to represent an estimate of the total expected utility metric for all of the combinations for which an expected utility metric was not directly calculated. The term “expected utility metric,” in some examples, may refer to a determination, calculation, and/or measurement of the utility that is projected to be produced if a potential match is executed. Although illustrated in terms of combinations, in some examples, the systems described herein may calculate expected utility metrics for different permutations of requestors (e.g., accounting for the order in which requestors may be picked up and/or dropped off by a transportation provider).

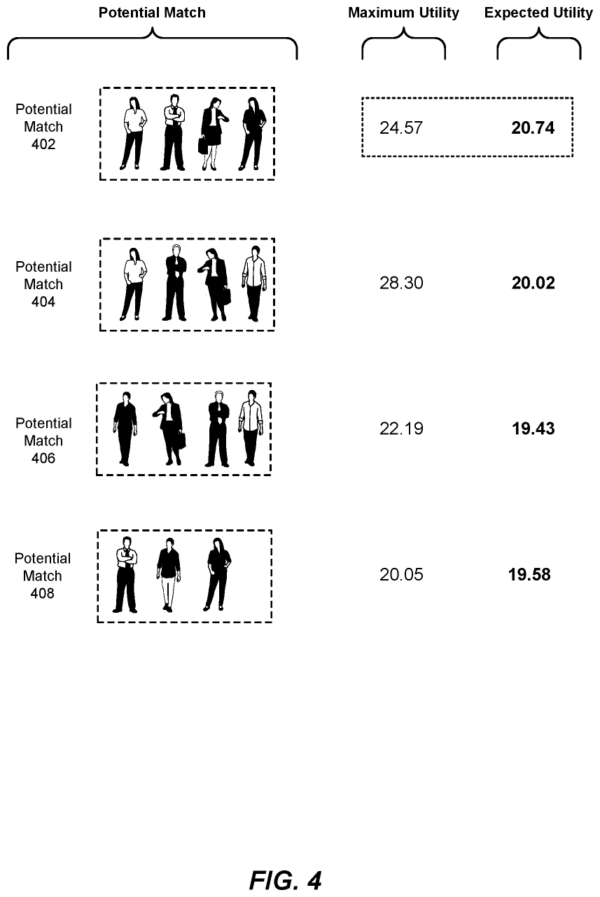

FIG. 4 illustrates an example set of utility metrics for different combinations of requestor devices. In some embodiments, the systems described herein may compare utility metrics for different potential matches to one another to determine which potential match to execute (i.e., which set of transportation requestor devices to match with a transportation provider device). In some examples, comparing the utility metrics of potential matches that are calculated based on the probabilities of various requestor devices cancelling may yield different matching decisions than comparing the maximum utility metrics of potential matches that are calculated with no regard for potential cancellations. For example, the systems described herein may compare potential matches 402, 404, 406, and/or 408 to determine which set of transportation requestor devices to match with a provider device. In this example, potential match 404 may have the highest maximum utility metric (i.e., the utility metric if no requestor devices cancel). However, due to different requestor cancellation probabilities between potential match 404 and potential match 402, potential match 402 may have a higher expected utility metric than potential match 404 despite having a lower maximum utility metric. Similarly, potential match 408 may have a higher expected utility metric than potential match 406 despite having both a lower maximum utility metric and a lower number of requestors. By calculating an expected utility metric for each potential match that takes into account the possibility of cancellation, the systems described herein may execute potential match 402 rather than potential match 404, potentially producing more utility for the dynamic transportation matching system and/or improving the experience of the transportation provider. Because the expected utility metric for potential match 402 is higher despite having a lower maximum utility metric than potential match 404, actualizing potential match 402 may result in increased system efficiency and/or utilization.

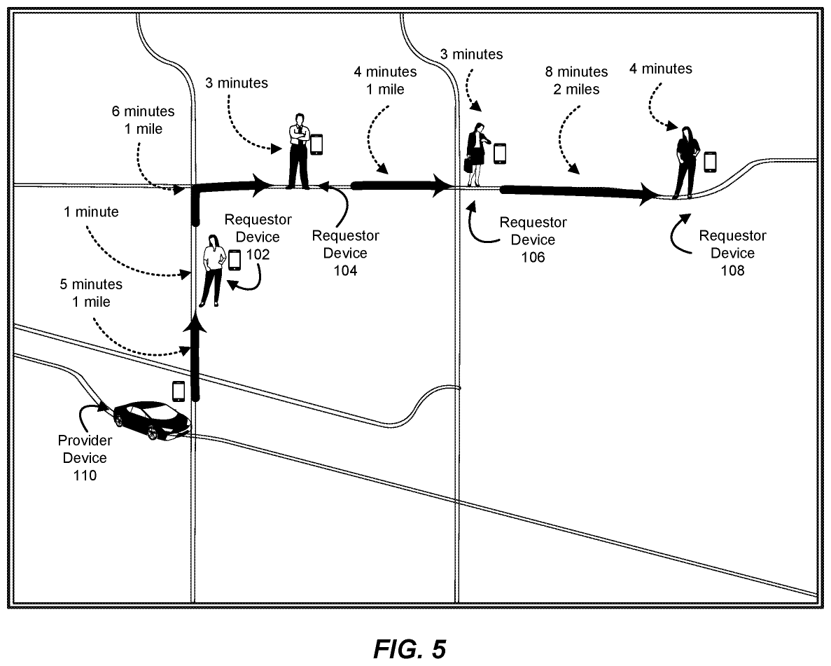

FIG. 5 illustrates an example set of transportation requestor devices and a provider device. In some embodiments, the systems described herein may take into account time and/or distance when determining or otherwise identifying a utility metric that represents the expected and/or maximum utility to the dynamic transportation matching system of a transportation requestor device. For example, the transportation provider associated with provider device 110 may travel one mile, with a travel time of five minutes, to meet the requestor associated with requestor device 102. In one example, the dynamic transportation matching system may determine (e.g., based on previous behavior, which may include historical data such as the difference in time between when a transportation provider arrives at a pick up location and when the requestor enters the vehicle to begin the transportation) that the requestor will take one minute to meet the provider once the provider arrives at the pickup point. If requestor device 102 cancels, the provider may only save one minute of time but may not reduce the travel distance to meet the requestor associated with requestor device 104. However, the dynamic transportation matching system may determine, when evaluating requestor devices for inclusion into the potential match (e.g., during the stage in the matching process where the systems described herein evaluate potential sets of matches for shared rides), that the requestor associated with requestor device 104 may take three minutes to meet the provider. Because of the increased wait time for that set of requestors (increasing the projected wait times and estimated arrival times for later requestors), the systems described herein may determine that providing transportation to requestor device 104 as combined with requestor devices 102, 106, and 108 has a lower utility metric than if the requestor device 104 as combined with requestor devices 102 and 108 because of a shorter projected wait time. Similarly, the systems described herein may determine that a requestor who requires a detour to pick up and/or drop off (e.g., based on a route determined by the dynamic transportation matching system for picking up and/or dropping off all of the transportation requestors in the potential match) may have a lower utility metric for that particular potential match (e.g., as opposed to a potential match that does not require a detour) than otherwise. In some examples, the probability of cancellation of a requestor device that adds significant time and/or distance to a potential match may not have a high impact on the expected utility of the match due to the savings in time and/or distance of not meeting the requestor partially cancelling out the lost utility from not transporting the requestor. In some examples, the systems described herein may apply different weightings to various factors such as wait time, additional trip time (compared to the same trip without that requestor), and/or additional trip distance when calculating the utility added by a transportation requestor to a potential match.

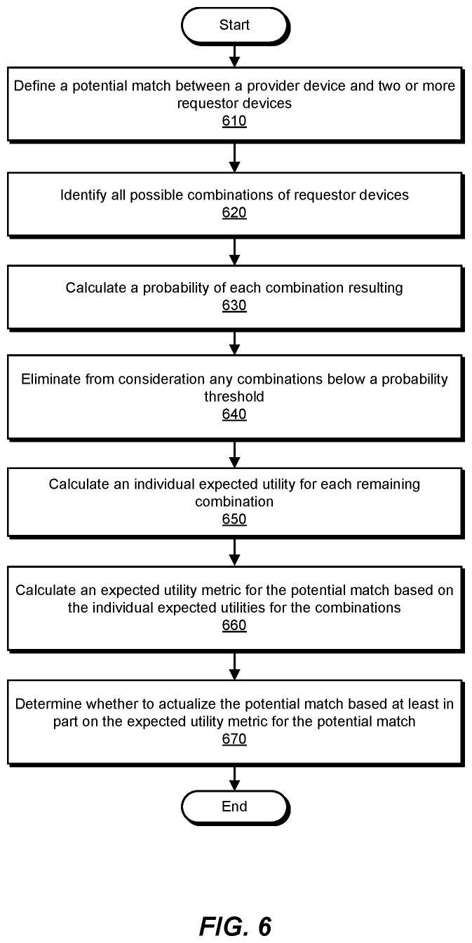

FIG. 6 is a flow diagram of an example method for matching multiple requestor devices with a provider device. In some embodiments, at step 610, the systems described herein may define a potential match between a provider device and two or more requestor devices. In some embodiments, as part of defining a potential match, the systems described herein may fetch potential matches (e.g., available provider devices and/or requestor devices with unfulfilled transportation requests), filter on hard constraints (e.g., distance, travel time, provider capacity, etc.), and/or retrieve and/or calculate conversions per passenger (e.g., the proportion of previous matches that the passenger accepted, that the passenger did not cancel, and/or that resulted in a completed trip for the passenger; and/or the probability that the passenger will accept, not cancel, and/or complete trips for future matches). At step 620, the systems described herein may identify all possible combinations of requestor devices. At step 630, the systems described herein may calculate the probability of each combination resulting from each transportation requestor present in the combination accepting the match and not cancelling and each combination requestor absent from the combination declining to accept the match or cancelling. In some embodiments, in order to perform more efficient calculations, the systems described herein may calculate cancellation probabilities independently from one another. For example, while in reality a later (in the pickup order) transportation requestor may be less likely to cancel if an earlier requestor cancels and shortens the later requestor's expected wait time, in some embodiments, the systems described herein may simplify the problem by calculating the later requestor's cancellation probability as independent from whether or not the earlier requestor cancels.

At step 640, the systems described herein may eliminate from consideration any combinations which fall below and/or do not exceed a probability threshold. For example, the systems described herein may determine that if a combination has less than 80 percent (or, e.g., 70 percent, 90 percent, 95 percent, etc.) chance of resulting (i.e., where all requestors accept the match and no requestors cancel), these systems may (at least initially) disregard the combination as a potential match in favor of combinations that have at least an 80 percent chance of resulting (i.e., fully converting into a shared ride with all included transportation requestors accepting and not cancelling). At step 650, the systems described herein may calculate an individual utility metric for each remaining combination. At step 660, the systems described herein may calculate an expected utility metric for the potential match based on the individual utility metrics for the combinations. As an example of steps 650 and 660, these systems may multiply the probability of each possible cancellation outcome for a combination of request or devices (including the probability that there are no cancellations) by the utility metric for each outcome and then sum the resulting products to produce the expected utility metric for the given combination of requestor devices. At step 670, the systems described herein may determine whether to execute the potential match based at least in part on the expected utility metric of the potential match. For example, the systems described herein may drop the potential match from consideration if the expected utility metric is too low (e.g., below a threshold). Additionally or alternatively, the systems described herein may compare different potential matches and execute the match with the highest expected utility metric and/or based on various factors of which the highest expected utility metric is one. In some examples, the systems described herein may apply this above-described approach to one or more transportation requestor device sessions pre-request and compare the overall expected value of the potential match with alternatives. For example, the systems described herein may compare expected utility metrics of different matches that allocate the transportation provider device within the dynamic transportation network and/or with different matches that provide transportation to the transportation requestor devices to determine whether to recommend shared transportation to the transportation requestor devices and/or the transportation provider device.

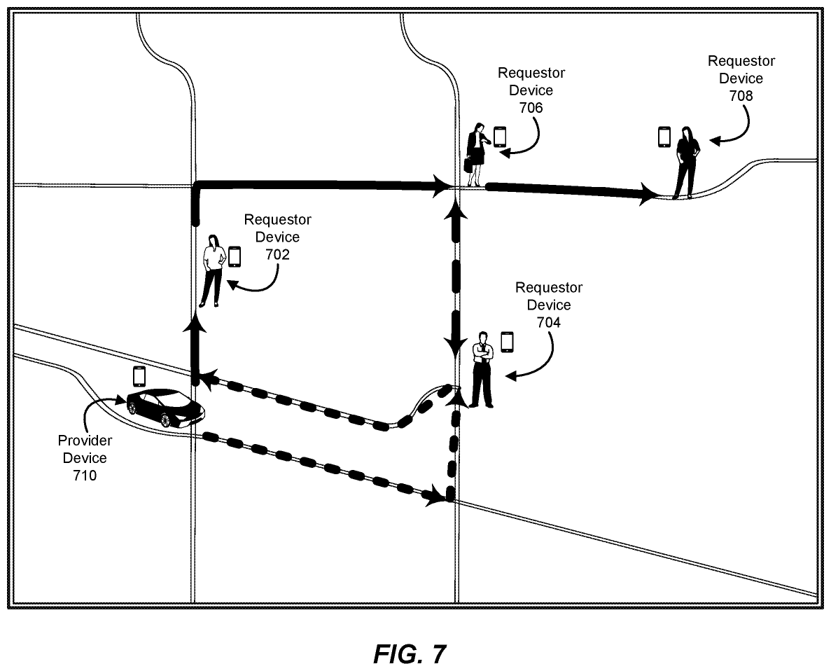

FIG. 7 illustrates an example set of transportation requestor devices and a provider device with different possible permutations. Although generally discussed in terms of combinations, in some embodiments, the systems described herein may calculate probabilities, utilities, and/or expected utility metrics for sets of permutations in place of and/or addition to sets of combinations. Because a requestor that is picked up later may have a greater probability of canceling (at least due to having more opportunity to cancel during a wait), accounting for permutations of transportation requestor devices based on pick-up order may allow for more nuanced comparison of different potential matches. For example, a provider associated with a provider device 710 may pick up a set of transportation requestors in the order of requestor device 702, requestor device 704, requestor device 706, and requestor device 708. However, the provider may also pick up the requestors in the order of requestor device 704, requestor device 702, requestor device 706, and requestor device 708. In some embodiments, these different orderings may be treated as different potential matches and may have expected values calculated separately. In other embodiments, these different orderings may be treated as one potential match and the systems described herein may calculate probabilities for each permutation as part of calculating the expected utility metric for the potential match. In addition, in some examples, the systems described herein may factor in different potential drop-off orderings for each potential match. For example, in some cases one drop-off ordering may result in a requestor being picked up earlier than otherwise, potentially impacting the projected cancellation probability of that requestor. Additionally, the utility of different drop-off orderings may be impacted by a cancellation (since the cancellation may reduce routing constraints) such that, when the probability of the cancellation is incorporated into routing decisions for drop-offs, the expected utility of the potential match is impacted.

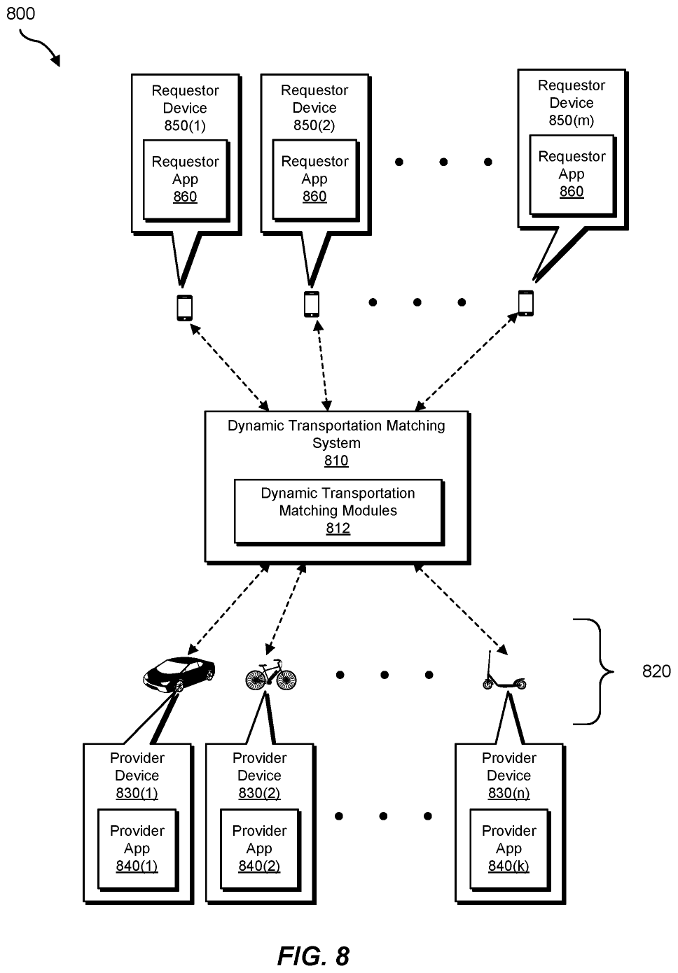

FIG. 8 illustrates an example system 800 for matching transportation requests with a dynamic transportation network that includes personal mobility vehicles and/or micro-mobility vehicles. As shown in FIG. 8, a dynamic transportation matching system 810 may be configured with one or more dynamic transportation matching modules 812 that may perform one or more of the steps described herein. Dynamic transportation matching system 810 may represent any computing system and/or set of computing systems capable of matching transportation requests. Dynamic transportation matching system 810 may be in communication with computing devices in each of a group of vehicles 820. Vehicles 820 may represent any vehicles that may fulfill transportation requests. In some examples, vehicles 820 may include disparate vehicle types and/or models. For example, vehicles 820 may include lane-bound vehicles and micro-mobility vehicles. In some examples, some of vehicles 820 may be standard commercially available vehicles. According to some examples, some of vehicles 820 may be owned by separate individuals (e.g., transportation providers). Furthermore, while, in some examples, many or all of vehicles 820 may be human-operated, in some examples many of vehicles 820 may also be autonomous (or partly autonomous). Accordingly, throughout the instant disclosure, references to a “transportation provider” (or “provider”) may, where appropriate, refer to an operator of a human driven vehicle, an autonomous vehicle control system, an autonomous vehicle, an owner of an autonomous vehicle, an operator of an autonomous vehicle, an attendant of an autonomous vehicle, a vehicle piloted by a requestor, and/or an autonomous system for piloting a vehicle. While FIG. 8 does not specify the number of vehicles 820, it may be readily appreciated that the systems described herein are applicable to hundreds of vehicles, thousands of vehicles, or more. In one example, dynamic transportation matching system 810 may coordinate transportation matchings within a single region for 50,000 vehicles or more on a given day. In some examples, vehicles 820 may collectively form a dynamic transportation network that may provide transportation supply on an on-demand basis to transportation requestors.

As mentioned above, dynamic transportation matching system 810 may communicate with computing devices in each of vehicles 820. The computing devices may be any suitable type of computing device. In some examples, one or more of the computing devices may be integrated into the respective vehicles 820. In some examples, one or more of the computing devices may be mobile devices. For example, one or more of the computing devices may be smartphones. Additionally or alternatively, one or more of the computing devices may be tablet computers, personal digital assistants, or any other type or form of mobile computing device. According to some examples, one or more of the computing devices may include wearable computing devices (e.g., a driver-wearable computing device), such as smart glasses, smart watches, etc. In some examples, one or more of the computing devices may be devices suitable for temporarily mounting in a vehicle (e.g., for use by a requestor and/or provider for a transportation matching application, a navigation application, and/or any other application suited for the use of requestors and/or providers). Additionally or alternatively, one or more of the computing devices may be devices suitable for installing in a vehicle and/or may be a vehicle's computer that has a transportation management system application installed on the computer in order to provide transportation services to transportation requestors and/or communicate with dynamic transportation matching system 810.

As shown in FIG. 8, vehicles 820 may include provider devices 830(1)-(n) (e.g., whether integrated into the vehicle, permanently affixed to the vehicle, temporarily affixed to the vehicle, worn by a driver of the vehicle, etc.). In some examples, provider devices 830 may include a provider apps 840(1)-(k). Provider apps 840(1)-(k) may represent any application, program, and/or module that may provide one or more services related to operating a vehicle and/or providing transportation matching services. For example, provider apps 840(1)-(k) may include a transportation matching application for providers and/or one or more applications for matching micro-mobility vehicles (MMVs) with requestor devices. In some embodiments, different types of provider vehicles may be provisioned with different types of provider devices and/or different provider applications. For example, MMVs may be provisioned with provider devices that are configured with a provider application that enables transportation requestors to reserve and/or operate the MMV while lane-bound and/or road-constrained vehicles (e.g., cars) may be provisioned with provider devices that are configured with a provider application that enables provider vehicle operators (e.g., transportation providers) to respond to requests from transportation requestors. In some examples, provider applications 840(1)-(k) may match the user of provider apps 840(1)-(k) (e.g., a transportation provider) with transportation requestors through communication with dynamic transportation matching system 810. In addition, and as is described in greater detail below, provider apps 840(1)-(k) may provide dynamic transportation matching system 810 with information about a provider (including, e.g., the current location of the provider and/or vehicle) to enable dynamic transportation matching system 810 to provide dynamic transportation matching and/or management services for the provider and one or more requestors. In some examples, provider apps 840(1)-(k) may coordinate communications and/or a payment between a requestor and a provider. According to some embodiments, provider apps 840(1)-(k) may provide a map service, a navigation service, a traffic notification service, and/or a geolocation service.

Additionally, as shown in FIG. 8, dynamic transportation matching system 810 may communicate with requestor devices 850(1)-(m). In some examples, requestor devices 850 may include a requestor app 860. Requestor app 860 may represent any application, program, and/or module that may provide one or more services related to requesting transportation matching services. For example, requestor app 860 may include a transportation matching application for requestors. In some examples, requestor app 860 may match the user of requestor app 860 (e.g., a transportation requestor) with transportation providers through communication with dynamic transportation matching system 810. In addition, and as is described in greater detail below, requestor app 860 may provide dynamic transportation matching system 810 with information about a requestor (including, e.g., the current location of the requestor) to enable dynamic transportation matching system 810 to provide dynamic transportation matching services for the requestor and one or more providers. In some examples, requestor app 860 may coordinate communications and/or a payment between a requestor and a provider. According to some embodiments, requestor app 860 may provide a map service, a navigation service, a traffic notification service, and/or a geolocation service.

Embodiments of the instant disclosure may include or be implemented in conjunction with a dynamic transportation matching system. A transportation matching system may arrange transportation on an on-demand and/or ad-hoc basis by, e.g., matching one or more transportation requestors with one or more transportation providers. For example, a transportation matching system may provide one or more transportation matching services for a networked transportation service, a ridesourcing service, a taxicab service, a car-booking service, an autonomous vehicle service, a personal mobility vehicle and/or micro-mobility vehicle service, or some combination and/or derivative thereof. The transportation matching system may include and/or interface with any of a variety of subsystems that may implement, support, and/or improve a transportation matching service. For example, the transportation matching system may include a matching system (e.g., that matches requestors to ride opportunities and/or that arranges for requestors and/or providers to meet), a mapping system, a navigation system (e.g., to help a provider reach a requestor, to help a requestor reach a provider, and/or to help a provider reach a destination), a reputation system (e.g., to rate and/or gauge the trustworthiness of a requestor and/or a provider), a payment system, and/or an autonomous or semi-autonomous driving system. The transportation matching system may be implemented on various platforms, including a requestor-owned mobile device, a computing system installed in a vehicle, a requestor-owned mobile device, a server computer system, or any other hardware platform capable of providing transportation matching services to one or more requestors and/or providers.

While various examples provided herein relate to transportation, embodiments of the instant disclosure may include or be implemented in conjunction with a dynamic matching system applied to one or more services instead of and/or in addition to transportation services. For example, embodiments described herein may be used to match service providers with service requestors for any service.

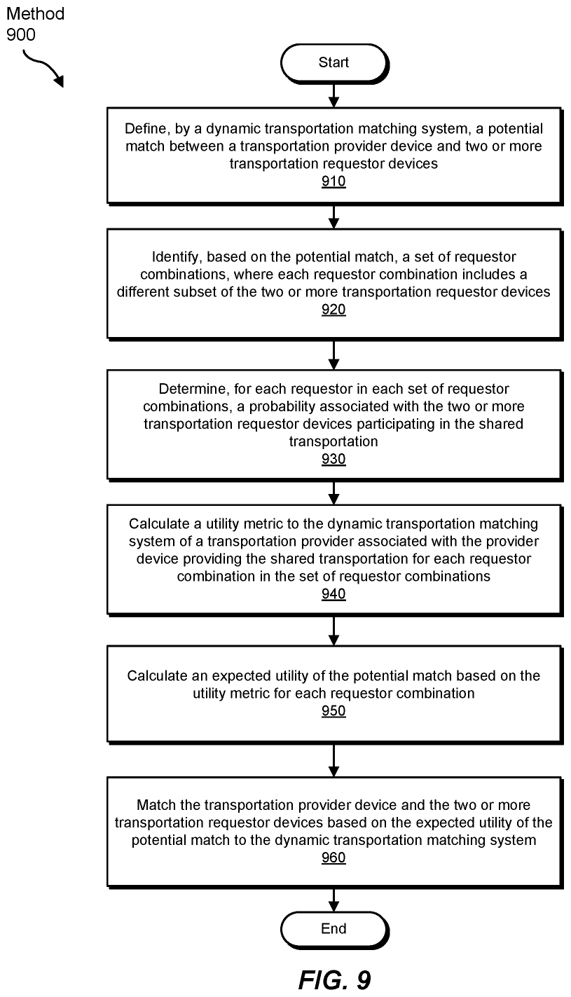

FIG. 9 illustrates an example computer-implemented method 900 for matching provider devices with multiple requestor devices. As shown in FIG. 9, at step 910, one or more of the systems described herein may define, by a dynamic transportation matching system, a potential match between a transportation provider device and two or more transportation requestor devices. At step 920, one or more of the systems described herein may identify, based on the potential match, a set of requestor combinations. Each identified requestor combination may include a different subset of the two or more transportation requestor devices. Each different subset may reflect a different projection of which of the two or more transportation requestor devices will not participate in the shared transportation. In some examples, systems described herein may identify the set of requestor combinations by, for each requestor combination, calculating a probability of the requestor combination resulting from each transportation requestor device absent from the requestor combination failing to participate in the shared transportation and each transportation requestor device present in the requestor combination participating in the shared transportation. In some embodiments, the systems described herein may exclude requestor combinations with a probability below a probability threshold from the set of requestor combinations.

At step 930, one or more of the systems described herein may determine, for each requestor in each set of requestor combinations, a probability associated with the two or more transportation requestor devices participating in the shared transportation. At step 940, one or more of the systems described herein may calculate, for each given requestor combination in the set of requestor combinations, a utility metric for the dynamic transportation matching system associated with the transportation provider providing the shared transportation to any of the given requestor combinations. In some examples, the systems described herein may calculate the utility to the dynamic transportation matching system of the transportation provider providing the shared transportation for each requestor combination in the set of requestor combinations by performing a series of calculations. First, these systems may calculate an individual expected utility metric for each requestor combination by calculating a probability of the requestor combination resulting from each transportation requestor device absent from the requestor combination failing to participate in the shared transportation and each transportation requestor device present in the requestor combination participating in the shared transportation. In addition, these systems may calculate a utility metric to the dynamic transportation matching system of providing the shared transportation to the subset of transportation requestor devices that includes the requestor combination. In some examples, the systems described herein may calculate the probability of the requestor combination resulting by predicting a probability that the subset of the two or more transportation requestor devices that are absent from the requestor combination will cancel a request for the shared transportation. In some examples, the systems described herein may calculate the probability of the requestor combination resulting by identifying a set of transportation requestor devices absent from the requestor combination and independently calculating a probability of an absence of each transportation requestor device. For example, the systems described herein may calculate the probability that each transportation requestor device will be absent from the shared match due to not accepting the match and/or due to cancelling after accepting the match. In some examples, the systems described herein may calculate the utility to the dynamic transportation matching system of the transportation provider providing the shared transportation for each requestor combination in the set of requestor combinations by calculating an expected distance traversed by the transportation provider device in the course of providing the shared transportation from a set of requested pick-up locations to a set of requested drop-off locations of the transportation requestor devices included in the requestor combination. For example, the systems described herein may determine that, all other things being equal (e.g., trip cost, provider utilization, etc.), a transportation requestor device that adds six miles to the trip provides less utility than a transportation requestor device that adds two miles to the trip. Additionally or alternatively, the systems described herein may calculate the utility to the dynamic transportation matching system of the transportation provider providing the shared transportation for each requestor combination in the set of requestor combinations by calculating an expected trip time for the transportation provider device in the course of providing the shared transportation to the transportation requestor devices included in the requestor combination. For example, the systems described herein may determine that a transportation requestor device that adds ten minutes to the expected trip time (e.g., over what the trip time would have been if the transportation requestor device were not included in the potential match) provides less utility than a transportation requestor device that adds two minutes to the trip time.

At step 950, the dynamic transportation matching system may calculate an expected utility of the potential match based on the utility metric for each requestor combination. At step 960, the dynamic transportation matching system may match the transportation provider device and the two or more transportation requestor devices based on the expected utility of the potential match to the dynamic transportation matching system. In one embodiment, the systems described herein may (i) define, by the dynamic transportation matching system, a second potential match between the transportation provider device and a different set of transportation requestor devices, (ii) calculate an expected utility of the second potential match, and (iii) match the transportation provider device and the different set of transportation requestor devices based on the expected utility of the second potential match exceeding the expected utility of the potential match. In some embodiments, in order to offer an efficient match, the systems described herein may calculate expected utility metrics for many different potential matches before offering a potential match to the transportation requestor devices and/or transportation provider devices.

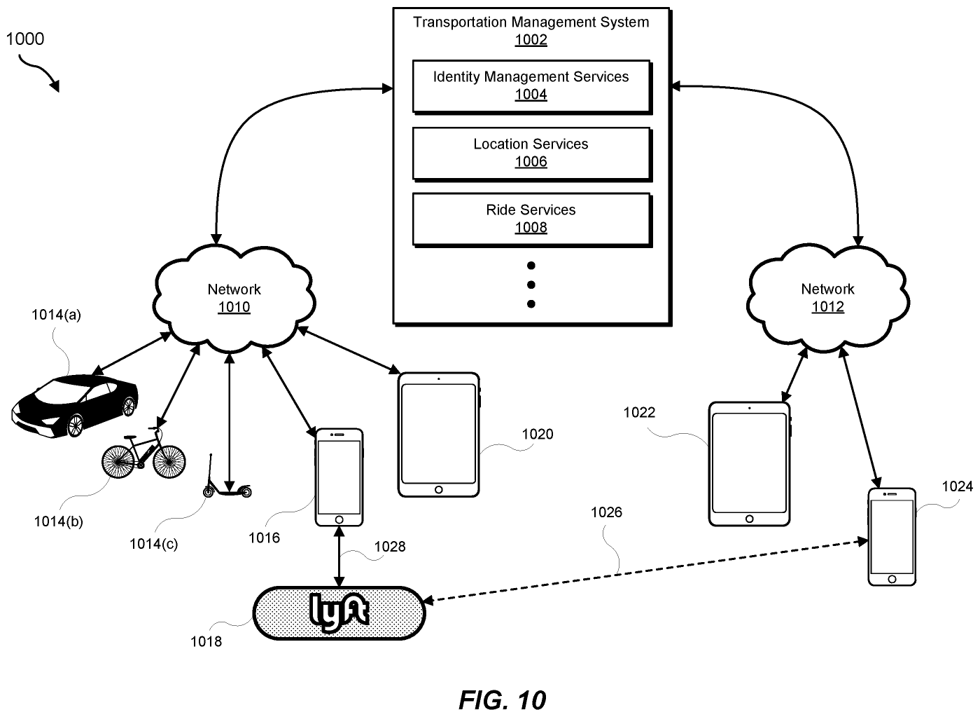

FIG. 10 shows a transportation management environment 1000, in accordance with various embodiments. As shown in FIG. 10, a transportation management system 1002 may run one or more services and/or software applications, including identity management services 1004, location services 1006, ride services 1008, and/or other services. Although FIG. 10 shows a certain number of services provided by transportation management system 1002, more or fewer services may be provided in various implementations. In addition, although FIG. 10 shows these services as being provided by transportation management system 1002, all or a portion of any of the services may be processed in a distributed fashion. For example, computations associated with a service task may be performed by a combination of transportation management system 1002 (including any number of servers, databases, etc.), one or more devices associated with a provider (e.g., devices integrated with managed vehicles 1014(a), 1014(b), and/or 1014(c); provider computing devices 1016 and tablets 1020; and transportation management vehicle devices 1018), and/or more or more devices associated with a ride requestor (e.g., the requestor's computing devices 1024 and tablets 1022). In some embodiments, transportation management system 1002 may include one or more general purpose computers, server computers, clustered computing systems, cloud-based computing systems, and/or any other computing systems or arrangements of computing systems. Transportation management system 1002 may be configured to run any or all of the services and/or software components described herein. In some embodiments, the transportation management system 1002 may include an appropriate operating system and/or various server applications, such as web servers capable of handling hypertext transport protocol (HTTP) requests, file transfer protocol (FTP) servers, database servers, etc.

In some embodiments, identity management services 1004 may be configured to perform authorization services for requestors and providers and/or manage their interactions and/or data with transportation management system 1002. This may include, e.g., authenticating the identity of providers and determining that they are authorized to provide services through transportation management system 1002. Similarly, requestors' identities may be authenticated to determine whether they are authorized to receive the requested services through transportation management system 1002. Identity management services 1004 may also manage and/or control access to provider and/or requestor data maintained by transportation management system 1002, such as driving and/or ride histories, vehicle data, personal data, preferences, usage patterns as a ride provider and/or as a ride requestor, profile pictures, linked third-party accounts (e.g., credentials for music and/or entertainment services, social-networking systems, calendar systems, task-management systems, etc.) and any other associated information. Transportation management system 1002 may also manage and/or control access to provider and/or requestor data stored with and/or obtained from third-party systems. For example, a requester or provider may grant transportation management system 1002 access to a third-party email, calendar, or task management system (e.g., via the user's credentials). As another example, a requestor or provider may grant, through a mobile device (e.g., 1016, 1020, 1022, or 1024), a transportation application associated with transportation management system 1002 access to data provided by other applications installed on the mobile device. In some examples, such data may be processed on the client and/or uploaded to transportation management system 1002 for processing.

In some embodiments, transportation management system 1002 may provide ride services 1008, which may include ride matching and/or management services to connect a requestor to a provider. For example, after identity management services module 1004 has authenticated the identity a ride requestor, ride services module 1008 may attempt to match the requestor with one or more ride providers. In some embodiments, ride services module 1008 may identify an appropriate provider using location data obtained from location services module 1006. Ride services module 1008 may use the location data to identify providers who are geographically close to the requestor (e.g., within a certain threshold distance or travel time) and/or who are otherwise a good match with the requestor. Ride services module 1008 may implement matching algorithms that score providers based on, e.g., preferences of providers and requestors; vehicle features, amenities, condition, and/or status; providers' preferred general travel direction and/or route, range of travel, and/or availability; requestors' origination and destination locations, time constraints, and/or vehicle feature needs; and any other pertinent information for matching requestors with providers. In some embodiments, ride services module 1008 may use rule-based algorithms and/or machine-learning models for matching requestors and providers.

Transportation management system 1002 may communicatively connect to various devices through networks 1010 and/or 1012. Networks 1010 and 1012 may include any combination of interconnected networks configured to send and/or receive data communications using various communication protocols and transmission technologies. In some embodiments, networks 1010 and/or 1012 may include local area networks (LANs), wide-area networks (WANs), and/or the Internet, and may support communication protocols such as transmission control protocol/Internet protocol (TCP/IP), Internet packet exchange (IPX), systems network architecture (SNA), and/or any other suitable network protocols. In some embodiments, data may be transmitted through networks 1010 and/or 1012 using a mobile network (such as a mobile telephone network, cellular network, satellite network, or other mobile network), a public switched telephone network (PSTN), wired communication protocols (e.g., Universal Serial Bus (USB), Controller Area Network (CAN)), and/or wireless communication protocols (e.g., wireless LAN (WLAN) technologies implementing the IEEE 802.12 family of standards, Bluetooth, Bluetooth Low Energy, Near Field Communication (NFC), Z-Wave, and ZigBee). In various embodiments, networks 1010 and/or 1012 may include any combination of networks described herein or any other type of network capable of facilitating communication across networks 1010 and/or 1012.

In some embodiments, transportation management vehicle device 1018 may include a provider communication device configured to communicate with users, such as drivers, passengers, pedestrians, and/or other users. In some embodiments, transportation management vehicle device 1018 may communicate directly with transportation management system 1002 or through another provider computing device, such as provider computing device 1016. In some embodiments, a requestor computing device (e.g., device 1024) may communicate via a connection 1026 directly with transportation management vehicle device 1018 via a communication channel and/or connection, such as a peer-to-peer connection, Bluetooth connection, NFC connection, ad hoc wireless network, and/or any other communication channel or connection. Although FIG. 10 shows particular devices communicating with transportation management system 1002 over networks 1010 and 1012, in various embodiments, transportation management system 1002 may expose an interface, such as an application programming interface (API) or service provider interface (SPI) to enable various third parties which may serve as an intermediary between end users and transportation management system 1002.

In some embodiments, devices within a vehicle may be interconnected. For example, any combination of the following may be communicatively connected: vehicle 1014, provider computing device 1016, provider tablet 1020, transportation management vehicle device 1018, requestor computing device 1024, requestor tablet 1022, and any other device (e.g., smart watch, smart tags, etc.). For example, transportation management vehicle device 1018 may be communicatively connected to provider computing device 1016 and/or requestor computing device 1024. Transportation management vehicle device 1018 may establish communicative connections, such as connections 1026 and 1028, to those devices via any suitable communication technology, including, e.g., WLAN technologies implementing the IEEE 802.12 family of standards, Bluetooth, Bluetooth Low Energy, NFC, Z-Wave, ZigBee, and any other suitable short-range wireless communication technology.

In some embodiments, users may utilize and interface with one or more services provided by the transportation management system 1002 using applications executing on their respective computing devices (e.g., 1016, 1018, 1020, and/or a computing device integrated within vehicle 1014), which may include mobile devices (e.g., an iPhone®, an iPad®, mobile telephone, tablet computer, a personal digital assistant (PDA)), laptops, wearable devices (e.g., smart watch, smart glasses, head mounted displays, etc.), thin client devices, gaming consoles, and any other computing devices. In some embodiments, vehicle 1014 may include a vehicle-integrated computing device, such as a vehicle navigation system, or other computing device integrated with the vehicle itself, such as the management system of an autonomous vehicle. The computing device may run on any suitable operating systems, such as Android®, iOS®, macOS®, Windows®, Linux®, UNIX®, or UNIX®-based or Linux®-based operating systems, or other operating systems. The computing device may further be configured to send and receive data over the Internet, short message service (SMS), email, and various other messaging applications and/or communication protocols. In some embodiments, one or more software applications may be installed on the computing device of a provider or requestor, including an application associated with transportation management system 1002. The transportation application may, for example, be distributed by an entity associated with the transportation management system via any distribution channel, such as an online source from which applications may be downloaded. Additional third-party applications unassociated with the transportation management system may also be installed on the computing device. In some embodiments, the transportation application may communicate or share data and resources with one or more of the installed third-party applications.

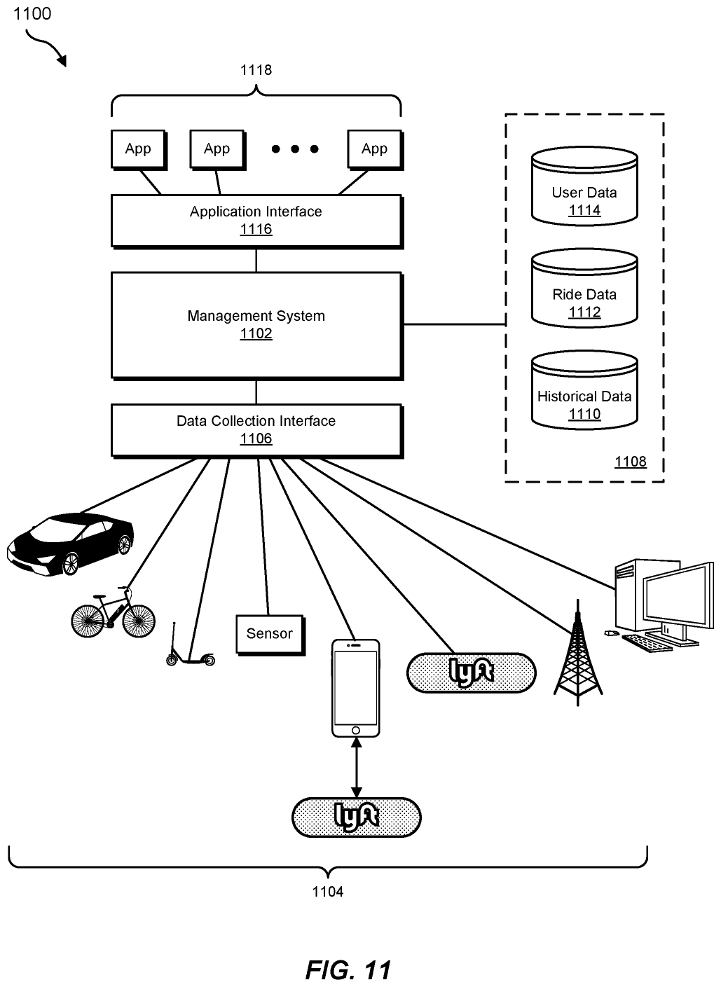

FIG. 11 shows a data collection and application management environment 1100, in accordance with various embodiments. As shown in FIG. 11, management system 1102 may be configured to collect data from various data collection devices 1104 through a data collection interface 1106. As discussed above, management system 1102 may include one or more computers and/or servers or any combination thereof. Data collection devices 1104 may include, but are not limited to, user devices (including provider and requestor computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 1106 can include, e.g., an extensible device framework configured to support interfaces for each data collection device. In various embodiments, data collection interface 1106 may be extended to support new data collection devices as they are released and/or to update existing interfaces to support changes to existing data collection devices. In various embodiments, data collection devices may communicate with data collection interface 1106 over one or more networks. The networks may include any network or communication protocol as would be recognized by one of ordinary skill in the art, including those networks discussed above.

As shown in FIG. 11, data received from data collection devices 1104 can be stored in data 1108. Data 1108 may include one or more data stores, such as databases, object storage systems and services, cloud-based storage services, and other data stores. For example, various data stores may be implemented on a non-transitory storage medium accessible to management system 1102, such as historical data 1110, ride data 1112, and user data 1114. Data 1108 can be local to management system 1102, or remote and accessible over a network, such as those networks discussed above or a storage-area network or other networked storage system. In various embodiments, historical data 1110 may include historical traffic data, weather data, request data, road condition data, or any other data for a given region or regions received from various data collection devices. Ride data 1112 may include route data, request data, timing data, and other ride related data, in aggregate and/or by requestor or provider. User data 1114 may include user account data, preferences, location history, and other user-specific data. Although certain data stores are shown by way of example, any data collected and/or stored according to the various embodiments described herein may be stored in data 1108.

As shown in FIG. 11, an application interface 1116 can be provided by management system 1102 to enable various apps 1118 to access data and/or services available through management system 1102. Apps 1118 may run on various user devices (including provider and requestor computing devices, such as those discussed above) and/or may include cloud-based or other distributed apps configured to run across various devices (e.g., computers, servers, or combinations thereof). Apps 1118 may include, e.g., aggregation and/or reporting apps which may utilize data 1108 to provide various services (e.g., third-party ride request and management apps). In various embodiments, application interface 1116 can include an API and/or SPI enabling third party development of apps 1118. In some embodiments, application interface 1116 may include a web interface, enabling web-based access to data 1108 and/or services provided by management system 1102. In various embodiments, apps 1118 may run on devices configured to communicate with application interface 1116 over one or more networks. The networks may include any network or communication protocol as would be recognized by one of ordinary skill in the art, including those networks discussed above, in accordance with an embodiment of the present disclosure.

While various embodiments of the present disclosure are described in terms of a networked transportation system in which the ride providers are human drivers operating their own vehicles, in other embodiments, the techniques described herein may also be used in environments in which ride requests are fulfilled using autonomous or semi-autonomous vehicles. For example, a transportation management system of a networked transportation service may facilitate the fulfillment of ride requests using both human drivers and autonomous vehicles. Additionally or alternatively, without limitation to transportation services, a matching system for any service may facilitate the fulfillment of requests using both human drivers and autonomous vehicles.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
one or more memories;
one or more physical processors configured to execute instructions from the one or more memories to perform operations comprising:
defining, by a dynamic transportation matching system, a potential match between a transportation provider device and two or more transportation requestor devices;
identifying, based on the potential match, a set of requestor combinations, wherein each requestor combination comprises a different subset of the two or more transportation requestor devices;
determining, for each requestor in each set of requestor combinations, a probability associated with the two or more transportation requestor devices participating in shared transportation;
calculating a utility metric for the dynamic transportation matching system for the transportation provider device to provide the shared transportation for each requestor combination in the set of requestor combinations;
calculating an expected utility metric of the potential match based on the utility metric for each requestor combination; and
matching the transportation provider device and the two or more transportation requestor devices based on the expected utility metric of the potential match to the dynamic transportation matching system.

2. The system of claim 1, wherein calculating the utility metric for each requestor combination comprises:
calculating a probability of the requestor combination resulting from:
each transportation requestor device absent from the requestor combination failing to participate in the shared transportation; and
each transportation requestor device present in the requestor combination participating in the shared transportation; and
weighting the utility metric by the calculated probability of the requestor combination resulting.

3. The system of claim 2, wherein calculating the probability of each transportation requestor device absent from the requestor combination failing to participate in the shared transportation comprises predicting a probability that each transportation requestor device absent from the requestor combination will cancel a request for the shared transportation.

4. The system of claim 2, wherein the calculating the probability of the requestor combination resulting comprises:
identifying a set of transportation requestor devices absent from the requestor combination; and
independently calculating a probability of an absence of each transportation requestor device in the set of transportation requestor devices absent from the requestor combination failing to participate in the shared transportation.

5. The system of claim 1, wherein the identifying the set of requestor combinations comprises:
for each requestor combination in the set of requestor combinations, calculating a probability of the requestor combination resulting; and
excluding any requestor combination with a probability below a probability threshold from the set of requestor combinations.

6. The system of claim 1, wherein calculating the utility metric for the dynamic transportation matching system of the transportation provider providing the shared transportation for each requestor combination in the set of requestor combinations comprises calculating an expected distance traversed by the transportation provider device from a set of requested pick-up locations to a set of requested drop-off locations.

7. The system of claim 1, wherein the calculating the utility metric for the dynamic transportation matching system of the transportation provider providing the shared transportation for each requestor combination in the set of requestor combinations comprises calculating an expected trip time for the transportation provider device from a set of requested pick-up locations to a set of requested drop-off locations.

8. The system of claim 1, wherein the one or more physical processors are further configured to execute instructions from the one or more memories to perform operations comprising:
defining a second potential match between the transportation provider device and a second set of transportation requestor devices;
calculating an expected utility metric of the second potential match; and
matching the transportation provider device and the second set of transportation requestor devices based on the expected utility metric of the second potential match exceeding the expected utility metric of the potential match.

9. A computer-implemented method comprising:
defining, by a dynamic transportation matching system, a potential match between a transportation provider device and two or more transportation requestor devices;
identifying, based on the potential match, a set of requestor combinations, wherein each requestor combination comprises a different subset of the two or more transportation requestor devices;
determining, for each requestor in the set of requestor combinations, a probability associated with the two or more transportation requestor devices participating in shared transportation;
calculating a utility metric for the dynamic transportation matching system for the provider device to provide the shared transportation for each requestor combination in the set of requestor combinations;
calculating an expected utility metric of the potential match based on the utility metric for each requestor combination; and
matching the transportation provider device and the two or more transportation requestor devices based on the expected utility metric.

10. The computer-implemented method of claim 9, wherein calculating the utility metric for each requestor combination comprises:
calculating a probability of the requestor combination resulting from:
each transportation requestor device absent from the requestor combination failing to participate in the shared transportation; and
each transportation requestor device present in the requestor combination participating in the shared transportation; and
weighting the utility metric by the calculated probability of the requestor combination resulting.

11. The computer-implemented method of claim 10, wherein calculating the probability of each transportation requestor device absent from the requestor combination failing to participate in the shared transportation comprises predicting a probability each transportation requestor device absent from the requestor combination will cancel a request for the shared transportation.

12. The computer-implemented method of claim 10, wherein calculating the probability of the requestor combination resulting comprises:
identifying a set of transportation requestor devices absent from the requestor combination; and
independently calculating a probability of an absence of each transportation requestor device in the set of transportation requestor devices absent from the requestor combination failing to participate in the shared transportation.

13. The computer-implemented method of claim 9, further comprising identifying the set of requestor combinations by:
for each requestor combination in the set of requestor combinations, calculating a probability of the requestor combination resulting; and
excluding any requestor combination with a probability below a probability threshold from the set of requestor combinations.

14. The computer-implemented method of claim 9, wherein calculating the utility metric for the dynamic transportation matching system of the transportation provider providing the shared transportation for each requestor combination in the set of requestor combinations comprises calculating an expected distance traversed by the transportation provider device from a set of requested pick-up locations to a set of requested drop-off locations.

15. The computer-implemented method of claim 9, wherein calculating the utility metric for the dynamic transportation matching system of the transportation provider providing the shared transportation for each requestor combination in the set of requestor combinations comprises calculating an expected trip time for the transportation provider device from a set of requested pick-up locations to a set of requested drop-off locations.

16. The computer-implemented method of claim 9, further comprising:
defining, by the dynamic transportation matching system, a second potential match between the transportation provider device and a second set of transportation requestor devices;
calculating an expected utility of the second potential match; and
matching the transportation provider device and the second set of transportation requestor devices based on the expected utility of the second potential match exceeding the expected utility of the potential match.

17. A computer-readable medium comprising:
computer-readable instructions that, when executed by at least one processor of a computing device, cause the computing device to:
define, by a dynamic transportation matching system, a potential match between a transportation provider device and two or more transportation requestor devices;
identify, based on the potential match, a set of requestor combinations, wherein each requestor combination comprises a different subset of the two or more transportation requestor devices;
determine, for each requestor in each set of requestor combinations, a probability associated with the two or more transportation requestor devices participating in shared transportation;
calculate a utility metric for the dynamic transportation matching system for the transportation provider device to provide the shared transportation for each requestor combination in the set of requestor combinations;
calculate an expected utility metric of the potential match based on the utility metric for each requestor combination; and
match the transportation provider device and the two or more transportation requestor devices based on the expected utility metric.

18. The computer-readable medium of claim 17, wherein the computer-readable instructions cause the computing device to calculate the utility metric for each requestor combination by:
calculating a probability of the requestor combination resulting from:
each transportation requestor device absent from the requestor combination failing to participate in the shared transportation; and
each transportation requestor device present in the requestor combination participating in the shared transportation; and
weighting the utility metric by the calculated probability of the requestor combination resulting.

19. The computer-readable medium of claim 18, wherein the computer-readable instructions cause the computing device to calculate the probability of each transportation requestor device absent from the requestor combination failing to participate in the shared transportation by predicting a probability that the transportation requestor devices absent from the requestor combination will cancel a request for the shared transportation.

20. The computer-readable medium of claim 18, wherein the computer-readable instructions cause the computing device to calculate the probability of the requestor combination resulting by:
identifying a set of transportation requestor devices absent from the requestor combination; and
independently calculating a probability of an absence of each transportation requestor device in the set of transportation requestor devices absent from the requestor combination failing to participate in the shared transportation.
